(19) United States
(12) Patent Application Publication
(10) Pub. No.: US 2026/0067159 A1
(43) Pub. Date: Mar. 5, 2026

(54) Network Device Configuration Difference Notification

(71) Applicant: Arista Networks, Inc., Santa Clara, CA (US)

(72) Inventors: Charanjith Reddy Kunduru, Cupertino, CA (US); Sebastian Sapa, Vancouver (CA)

(21) Appl. No.: 18/821,479

(22) Filed: Aug. 30, 2024

(51) Int. Cl. H04L 41/082; H04L 41/0859; H04L 67/146

(52) U.S. Cl. CPC H04L 41/082; H04L 41/0859; H04L 67/146

(57) ABSTRACT

A network device may operate using configuration information such as running configuration. Network device processing circuitry may receive an instruction to apply a configuration update to the running configuration. Responsive to the configuration update being applied, the processing circuitry may notify external equipment. The notification may include the changes to the running configuration, resulting from the configuration update, and may include contextual information for the configuration update.

### BACKGROUND

A communication system can include multiple network devices that are interconnected to form a network for conveying network traffic between hosts. A network device can maintain device configuration information such as a running configuration information which specifies the manner in which the network device operates. The running configuration information can be changed during device operation to update the manner in which the network device operates.

### BRIEF DESCRIPTION OF THE DRAWINGS

FIG. 1 is a diagram of an illustrative networking system having network device(s) communicatively coupled to external equipment in accordance with some embodiments.

FIG. 2 is a diagram of an illustrative network device in accordance with some embodiments.

FIG. 3 is a diagram of illustrative processing circuitry configured to apply a device configuration update in accordance with some embodiments.

FIG. 4 is a diagram of illustrative processing circuitry configured to maintain device configuration update information in accordance with some embodiments.

FIG. 5 is a diagram of illustrative processing circuitry configured to output device configuration difference information in accordance with some embodiments.

FIG. 6 is a flowchart of illustrative operations for providing device configuration difference information in accordance with some embodiments.

### DETAILED DESCRIPTION

A network can convey network traffic (e.g., in the form of frames, packets, etc., and/or in other formats) between hosts or generally between devices in the network. A network device can maintain device configuration information, such as running configuration information (sometimes referred to simply as running configuration), which specifies the manner in which the network device operates. The network device may also maintain other device configuration information such as startup configuration information (sometimes referred to simply as a startup configuration) which specifies the configuration of the network device upon startup and which can be the same as or different from the running configuration. Network device configuration information such as the running configuration may be updated during the course of device operation to dynamically update the manner in which the device operates. It may be desirable to monitor such updates and provide notifications containing differences resulting from the updates to the configuration and containing other contextual information surrounding the updates (e.g., the user making the update, the time at which the configuration is updated, the configuration session from which update changes are obtained, etc.).

To facilitate these monitoring and notification operations, a network device may be configured to generate and store a record indicative of the configuration update. The record can identify the differences between different versions of the configuration information and contextual information surrounding the configuration update. The network device may further output a notification containing at least some of the record information in response to the configuration change, e.g., to inform an administrator device and/or other device management equipment of the configuration change. Configured in this manner, the network device can notify an administrator of any changes in device configuration in real-time and in an easily-digestible format indicating additions, removals, and/or other modifications with respect to the previous version of the configuration information and/or the context in which the change is applied. Accordingly, given the conciseness of the information for conveyance, even when frequent changes are applied to numerous network devices, the network administrator can be kept apprised of device configurations of network devices across the network, among other advantages imparted by the embodiments described herein.

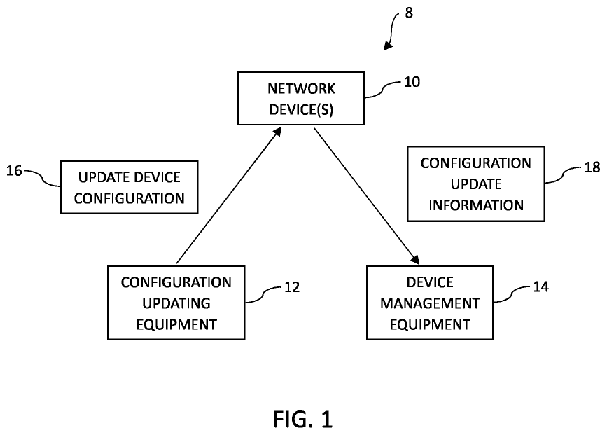

An illustrative networking system that includes one or more network devices configured to maintain, provide notification(s) based on, or otherwise handle device configuration differences (resulting from configuration updates) is shown in FIG. 1. In the example of FIG. 1, the networking system may include one or more components of a network such as network 8. Network 8 may have any suitable scope. As examples, network 8 may include, be, and/or form part of one or more local segments, one or more local subnets, one or more local area networks (LANs), one or more virtual local area networks (VLANs), one or more data center networks, one or more campus area networks, a wide area network, etc. Network 8 may include a wired network portion based on wired technologies or standards such as Ethernet (e.g., using copper cables and/or fiber optic cables) and, if desired, may include a wireless network portion such as one or more wireless local area networks (WLANs) (e.g., wireless networks compliant with the IEEE 802.11 family of standards) provided by wireless access point(s). If desired, network 8 may include internet service provider networks (e.g., the Internet) or other public service provider networks, private service provider networks (e.g., multiprotocol label switching (MPLS) networks), and/or other types of networks such as telecommunication service provider networks.

Network 8 may be implemented using and include one or more network devices 10 that handle (e.g., process by switching, routing, forwarding, modifying, etc.) network traffic to convey information for user applications between end hosts and/or for other applications, services, and functions generally between devices (e.g., network devices and/or end host devices). Network 8 can include networking equipment forming a variety of network devices 10 that interconnect end hosts of network 8. Network devices 10 of network 8 may include one or more wireless access points, one or more switches (e.g., single-layer (Layer 2) switches, multi-layer (Layer 2 and Layer 3) switches, etc.), one or more bridges, one or more routers or gateways, one or more hubs, one or more repeaters, one or more firewalls, one or more devices serving other networking functions, one or more devices that include the functionality of two or more of these devices, and/or management equipment that manage and control the operation of one or more of other network devices.

End hosts of network 8 can include computers, servers, portable electronic devices such as cellular telephones and laptops, other types of specialized or general-purpose host computing equipment (e.g., running one or more client-side and/or server-side applications), network-connected appliances or devices such as cameras, thermostats, wireless sensors, medical, health, or other sensors, lighting fixtures, speakers, printers, controllers, and other network-connected equipment that serve as input-output devices and/or computing devices in a distributed networking system, devices used by network administrators (sometimes referred to as administrator devices), network service devices, and/or management equipment that manage and control the operation of one or more of other end hosts and/or network devices. These different types of equipment and/or devices based on which hosts of network 8 are implemented may sometimes be referred to herein generally as (end) host devices.

To manage and/or monitor the operations of network 8, external equipment (external to a network device 10) such as configuration updating equipment 12 and/or device management equipment 14 may be communicatively coupled to network device 10. In some instances, equipment 12 and 14 may be implemented as separate equipment, as separate devices, and/or in separate systems (controlled by different users or entities). As an example, in these instances, a first device implementing equipment 14 may be notified of activities (e.g., changing of network device configuration) performed by a second device implementing equipment 12. In other instances, equipment 12 and 14 may be the same equipment, device, or system. As an example, in these instances, the same device may receive notification (e.g., confirmation) of activities that the device itself instructed network device 10 to perform.

External equipment (e.g., equipment 12 and/or equipment 14) communicatively coupled to network device 10 may include administrator device(s). An illustrative administrator device may be a computing device (e.g., a laptop, a computer), etc. operated by a network administrator (e.g., with a user with administrative-level access to network 8, thereby allowing the user to modify network device configuration or other network configuration and/or to receive notifications of network information). The computing device may include processing circuitry, memory circuitry, and input-output components (e.g., wireless communication circuitry, wired communication circuitry, and/or other circuitry that provide network interfaces that provide connectivity to network device 10, user input-output components such as a display, a keyboard, a mouse, etc. that provide user interfaces to facilitate the reception of user input and provide output to the user). The computing device (e.g., network interfaces provided thereon) may be coupled to network device 10 via a direct cable connection (e.g., without other intervening network devices) or via intervening network devices (e.g., through one or more other devices 10, through portions of network 8 such as the Internet, etc.).

In one illustrative implementation of the networking system in FIG. 1, equipment 12 may include or be a first administrator device and equipment 14 may include or be a second administrator device. This implementation is merely illustrative.

If desired, the external equipment (e.g., equipment 12 and/or equipment 14) may include device management servers (sometimes referred to as network management servers or network monitoring servers). The servers may be implemented on server equipment. The server equipment may include server hardware such as one or more blade servers, one or more rack servers, and/or one or more tower servers. Compute devices and storage devices for implementing the functions of these servers may be provided as part of the server hardware. The compute devices may include one or more processors or processing units based on any suitable processor architecture(s). The storage devices may include non-volatile memory such as hard disk drive storage and solid-state storage, volatile memory such as random-access memory, and/or other storage circuitry. The storage devices may include one or more non-transitory (tangible) computer-readable storage media that store the operating system software and/or any other software code. The compute devices may run (e.g., execute) an operating system and/or other software and firmware stored on the one or more non-transitory computer-readable storage media to perform the desired operations of the server(s) (e.g., to provide the desired services and/or applications).

An illustrative device management server may execute services and/or applications for configuring, monitoring, and/or otherwise managing the operation of network device(s) 10 (e.g., by updating device configurations, by receiving notifications of configuration updates, etc.). In some illustrative scenarios, a device management server may manage the operations of network device(s) 10 (e.g., by updating device configuration and/or receiving notification of device configuration updates) based on network telemetry data, with or without receiving user input from an administrator device.

In some illustrative scenarios, a device management server may be communicatively coupled to an administrator device, may provide a user interface (e.g., a graphical user interface) at the administrator device through which the device management server receives user input from the administrator device, and may manage the operations of network device(s) 10 based on the received user input. In these illustrative scenarios, equipment 12 and/or equipment 14 may each include an administrator device and a server through which the administrator device accesses the configuration of network device 10 (e.g., to update device configuration and/or to receive device configuration states and other device information).

Depending on their configuration, equipment 12, equipment 14, and network devices 10 may communicate with each other in any suitable manner (e.g., via different suitable communication paths). As an example, these communication paths may include network paths through a portion of network 8 (e.g., through some network devices 10 therein, using the Internet, etc.).

Still referring to FIG. 1, a network device 10 may store network device configuration information (e.g., startup configuration information, running configuration information, etc.) that specify or define the manner in which network device 10 will operate or is operating. In illustrative examples described herein, network device 10 may operate with a locally stored running configuration (sometimes referred to running configuration information) that defines network device operating behavior (e.g., traffic switching behavior, traffic routing behavior, enabled protocols, protocol parameters, enabled networking features such as traffic sampling, traffic mirroring, etc., external user access or user login behavior, etc.). The running configuration (information) may be maintained (e.g., stored) in one or more running configuration files, in one or more data structures, and/or generally in any suitable manner.

As shown in FIG. 1, equipment 12 may sometimes convey an indication 16 (e.g., an instruction accompanied by a configuration change) to update device configuration of network device 10. Responsive to receiving indication 16, network device 10 may update its configuration information (e.g., its running configuration) based on parameters and/or other information in indication 16. Network 8 may include numerous network devices 10, each of which may have its configuration frequently updated in this manner. Accordingly, it may be cumbersome for a network administrator to manually access the corresponding network device 10 to track each of these updates, especially when the administrator may not be aware of some of these updates taking place. Further, even when the network administrator is notified of a configuration update by network device 10, it may still be burdensome for the network administrator to examine the locally stored (running) configuration information at the network device 10 to determine what changes have been applied (e.g., which requires at least the network administrator obtaining a previous version of the configuration information). It can often also be difficult to determine how the configuration update was made (e.g., for troubleshooting, for determining unauthorized and/or faulty updates, for determining unauthorized user access, etc.) To simplify the process of network management and monitoring, network device(s) 10 may each be configured to output message(s) containing configuration update information 18 to device management equipment 14 (e.g., an administrator device). The output of configuration update information 18 may be responsive to each instance of device configuration update (resulting from a corresponding indication 16). Configuration update information 18 may include configuration differences (or configuration changes) based on the applied configuration update and may include other information providing context on how the configuration update was made. In such a manner, equipment 14 may be notified in real-time when there is any change to network device (running) configuration information across network 8. The format of information 18 to include configuration differences (e.g., additions, removals, and/or other modifications in the configuration information) and contextual information obviates the need for a network administrator to manual access, examine, and compare the locally stored configuration information of the network device, while also allowing the network administrator to make other determinations (e.g., whether an unauthorized configuration update was applied by equipment 12 or by an unauthorized entity, how a faulty update was applied, etc.) based on the provided additional contextual information.

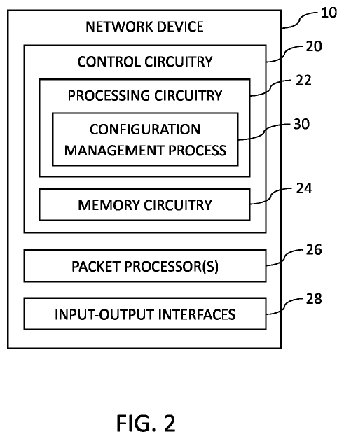

FIG. 2 is a diagram of an illustrative network device that may be used to implement any of network device(s) 10 in FIG. 1. As shown in FIG. 2, an illustrative network device 10 may include control circuitry 20 having processing circuitry 22 and memory circuitry 24, one or more packet processors 26, and input-output interfaces 28 (e.g., network interfaces implemented on exterior ports). In one illustrative arrangement, network device 10 may be or form part of a modular network device system (e.g., a modular switch system having removably coupled modules usable to flexibly expand characteristics and capabilities of the modular switch system such as to increase ports, provide specialized functionalities, etc.). In another illustrative arrangement, network device 10 may be a fixed-configuration network device (e.g., a fixed-configuration switch having a fixed number of ports and/or a fixed hardware configuration).

Processing circuitry 22 may include one or more processors such as central processing units (CPUs), graphics processing units (GPUs), microprocessors, general-purpose processors, host processors, microcontrollers, digital signal processors, programmable logic devices such as field programmable gate array (FPGA) devices, application specific system processors (ASSPs), application specific integrated circuit (ASIC) processors, and/or other types of processors.

Processing circuitry 22 may run (e.g., execute) a network device operating system and/or other software/firmware that is stored on memory circuitry 24. Memory circuitry 24 may include one or more non-transitory (tangible) computer-readable storage media that store the operating system software and/or any other software code, sometimes referred to as program instructions, software, data, instructions, or code. In particular, memory circuitry 24 may include non-volatile memory (e.g., flash memory, electrically-programmable read-only memory, a solid-state drive, hard disk drive storage, etc.), volatile memory (e.g., static or dynamic random-access memory), removable storage devices (e.g., storage devices removably coupled to device 10), and/or other types of memory circuitry.

Processing circuitry 22 and (at least a portion of) memory circuitry 24 as described above may sometimes be referred to collectively as control circuitry 20 (e.g., implementing a control plane of network device 10). Accordingly, processing circuitry 22 may also sometimes be referred to as control plane processing circuitry 22. As just a few examples, processing circuitry 22 may execute network device control plane software such as operating system software, routing policy management software, routing protocol agents or processes, routing information base agents, and other control software, may be used to support the operation of protocol clients and/or servers (e.g., to form some or all of a communications protocol stack), may be used to support the operation of packet processor(s) 26, may store packet forwarding information, may execute packet processing software, and/or may execute other software instructions that control the functions of network device 10 and the other components therein. These operations performed by processing circuitry 22 may make use of the information (e.g., parameters) provided in the running configuration such that device 10 operates in the intended (configured) manner.

Packet processor(s) 26 may be used to implement a data plane or forwarding plane of network device 10 and may therefore sometimes be referred to herein as data plane processor(s) 26 or data plane processing circuitry 26. Packet processor(s) 26 may include one or more processors such as programmable logic devices (e.g., field programmable gate array (FPGA) devices), application specific system processors (ASSPs), application specific integrated circuit (ASIC) processors, central processing units (CPUs), graphics processing units (GPUs), microprocessors, general-purpose processors, host processors, microcontrollers, digital signal processors, and/or other types of processors.

A packet processor 26 may receive incoming (ingress) network traffic via input-output interfaces 28, parse and analyze the received network traffic, process the network traffic based on packet forwarding decision data (e.g., in a forwarding information base) and/or in accordance with network protocol(s) or other forwarding policy, and forward (or drop) the network traffic accordingly (e.g., egress the processed network traffic via input-output interfaces 28). These operations performed by processing circuitry 26 may make use of the information (e.g., parameters) provided in the running configuration such that device 10 operates in the intended (configured) manner. The packet forwarding decision data may be stored on memory circuitry integrated as part of and/or separate from packet processor 26 (e.g., on content-addressable memory), and/or on a portion of memory circuitry 24. Memory circuitry for packet processor 26 may include volatile memory, non-volatile memory, and/or other types of memory circuitry.

Input-output interfaces 28 may include one or more different types of communication interfaces such as Ethernet interfaces, optical interfaces, and/or other types of communication interfaces for connecting network device 10 to the Internet, a local area network, a wide area network, a mobile network, and/or generally other network device(s) 10, peripheral devices, and computing equipment (e.g., host equipment as server equipment, host devices, etc.). In illustrative configurations described herein as an example, input-output interfaces 28 may include Ethernet interfaces implemented using and therefore include (Ethernet) ports. In particular, physical layer and/or data link layer interface circuitry in network device 10 may be coupled to the ports and use the ports to form Ethernet interfaces with the desired interface configurations.

If desired, network device 10 may include other components such as input-output devices (e.g., devices that provide user output such as a display device or one or more status lights, devices that gather user input such as one or more buttons, etc.). If desired, the other components on network device 10 may include power supply components, power management components, a system bus and/or other communication paths that couple the components of network device 10 to one another, etc. As an example, each component of network device 10 may be coupled to control circuitry 20 (e.g., processing circuitry 22 and/or memory circuitry 24) via one or more paths that enable the reception and transmission of control signals, data, and/or other information therebetween.

A network device 10 (e.g., as described in connection with FIGS. 1 and 2) may be configurable to operate in different manners in the network. As examples, depending on its configuration, network device 10 may form different numbers and types of network interfaces, route network traffic in different manners, switch network traffic in different manners, execute different protocols, enable different features, etc. In particular, this type of configuration information defining the manner in which device 10 operates or should operate may be stored (e.g., in memory circuitry 24) as one or more pieces of configuration information.

Network device 10 (e.g., memory circuitry 24) may store different types of configuration information specifying device configuration for use in different scenarios. In particular, device 10 may store a collection of startup configuration data specifying device startup configuration information, may store a collection of running configuration data specifying device running configuration information, and/or may store other types of device configuration information. In illustrative configurations described herein as examples, some types of device configuration information such as running configuration information may be updated dynamically during normal operation of network device 10.

To facilitate the management of device configuration information, processing circuitry 22 may execute a configuration management process 30 (e.g., by executing corresponding software instructions stored on memory circuitry 24). Configuration management process 30 (sometimes referred to as a configuration management agent 30) may, among other functions, perform operations to modify, provide access to, and/or otherwise handle device configuration information such as startup configuration information, running configuration information, etc. Configurations in which process 30 manages (e.g., performs configuration updates of) running configuration information are sometimes described herein as examples. If desired, process 30 may manage other types of configuration information (e.g., startup configuration information) in addition to or instead of running configuration information.

In illustrative configurations sometimes described herein as an example, processing circuitry 22 (e.g., when executing process 30) may also perform certain operations such as the generating, maintaining, outputting, and/or other types of handling of device configuration difference information as described herein (e.g., as described in connection with FIGS. 1-6).

This example is merely illustrative. If desired, processing circuitry 22 may execute other processes instead of or in addition to process 32 to perform these operations.

In general, processing circuitry 22 may sometimes be referred to as being configured to perform these operations in connection with the updating and management of network device configuration information, the generation and handling of configuration difference information, the notification of external equipment based on configuration updates, instead of referring to process 32 and/or other processes that may specifically perform these operations. These operations may be stored as (software) instructions on the one or more non-transitory computer-readable storage media (e.g., in portion(s) of memory circuitry 24 in network device 10), The corresponding processing circuitry (e.g., one or more processors of processing circuitry 22 in network device 10) may process or execute the respective instructions to perform these operations.

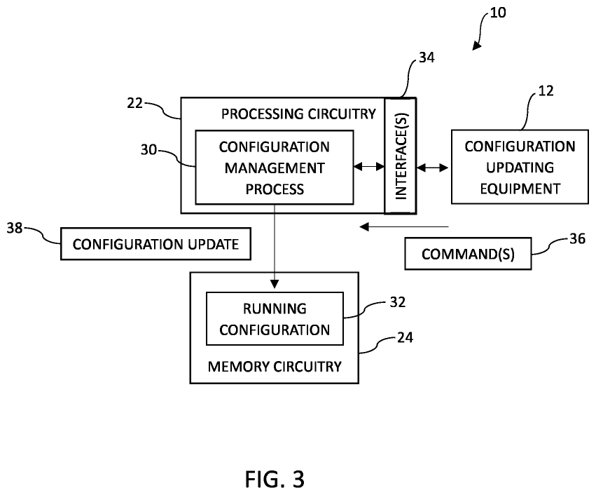

FIG. 3 is a diagram of illustrative processing circuitry and memory circuitry in a network device (e.g., device 10 in FIGS. 1 and 2) configured to update device configuration based on an instruction and/or other input from configuration updating equipment 12. As shown in FIG. 3, processing circuitry 22 may provide (software) interface(s) 34 such as one or more application programming interfaces (APIs) and/or a command line interface (CLI). Interfaces 34 may be provided by corresponding processes or agents on processing circuitry 22 (e.g., a command line interpreter process, a process that facilitates management using OpenConfig, etc.). Using interface(s) 34 (and corresponding input-output interfaces 28 in FIG. 2), processing circuitry 22 may communicate with external equipment such as network device configuration updating equipment 12 (e.g., an administrator devices, a device management server, etc.). Based on communication with equipment 12, processing circuitry 22 (e.g., when executing process 30) may obtain (e.g., receive) input such as one or more commands 36 from a network administrator operating equipment 12, from a device management application or service implemented on equipment 12, and/or from other sources of device configuration information.

Processing circuitry 22 (e.g., when executing process 30) may apply a configuration update 38 to update configuration information stored on memory circuitry 24 based on commands 36. In particular, processing circuitry 22 may update running configuration 32 (sometimes referred to as running configuration information 32) stored on memory circuitry 24 based on commands 36 (specifying the changes to running configuration 32). Running configuration 32 may be stored in a system database and may be accessible by other processes or agents executing processing circuitry 22 (e.g., to facilitate operation of network device 10 based on the parameters, settings, or other information specified in running configuration 32).

Running configuration 32 may be updated at different times, by different users, using different mechanisms, and generally in different contexts. As an example, configuration updating equipment 12 (e.g., an administrator device) may establish a secure session (e.g., using Secure Shell (SSH) protocol, via a device management server, etc.) with network device 10. Equipment 12 may provide commands 36 via interface 34 (e.g., a command line interface) to change running configuration 32 of device 10. In one example, these commands 36 may be processed and applied by processing circuitry 22 in a command-by-command or line-by-line manner (e.g., through the command line interface), each command 36 being a separate instance of configuration update 38. Accordingly, each command may serve as a separate instruction to apply the change in command 36.

As another example, equipment 12 may initiate a configuration session in which draft commands are provided via interface 34 (e.g., a command line interface). The draft commands may be applied (e.g., committed) by a user (e.g., based on processing circuitry 22 receiving user input or generally an input instruction) to finalize the changes indicated by the draft commands and to collectively apply all of the draft commands to update running configuration 32. Accordingly, these draft commands, once applied, may be used as finalized commands 36 by processing circuitry 22 to provide a single instance of configuration update 38. Using the configuration session, numerous draft changes can be made to a copy of the running configuration, and the changes may be collectively applied by processing circuitry 22 to the actual running configuration 32 only when the changes are committed or applied (e.g., by an instruction to apply the changes in the configuration session received from equipment 12).

In some illustrative scenarios, running configuration 32 may be updated in an undesirable manner (e.g., the updated configuration information may result in device 10 exhibiting adverse behavior or being non-operational, configuration information may be inadvertently updated, configuration information may be updated by an unauthorized user, etc.). Accordingly, in these scenarios and in other scenarios (e.g., to enhance network visibility and management), it may be desirable to facilitate tracking of configuration information updates to identify and provide notification of (undesired) updates to the configuration information. The notification of configuration information updates may include the changes to the configuration information and other contextual information associated with the configuration update.

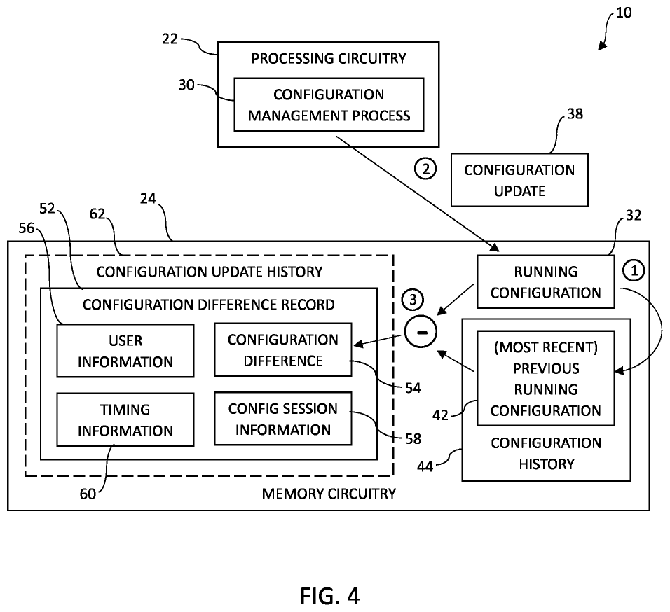

To facilitate this identification and notification process, a network device 10 may be configured to generate and maintain configuration differences in response to configuration updates. FIG. 4 is a diagram of illustrative network device processing circuitry 22 configured to maintain (e.g., store and update) configuration difference information on memory circuitry 24.

In the example of FIG. 4, processing circuitry 22 may maintain configuration difference information in the form of record 52 on memory circuitry 24. To generate the configuration difference information, processing circuitry 22 may maintain a network device configuration history 44 on memory circuitry 24. Configuration history 44 may include past versions of the running configuration such as the most recent previous running configuration 42 (e.g., the version of running configuration replaced by or immediately preceding the current version of running configuration 32).

In general, configuration history 44 may include any number of past versions of running configuration (e.g., the most recent version of running configuration 42, the second-most recent version of running configuration,. the oldest version of running configuration). Memory circuitry 24 may store these past versions of running configuration in configuration history 44 as complete collections of past running configuration data. If desired, memory circuitry 24 may store these past versions of running configuration in configuration history 44 in a repository (e.g., a Git repository) each in the form of a version of running configuration based on a past version of running configuration.

Processing circuitry 22 may generate a configuration difference record 52 for each instance of configuration update 38. In particular, processing circuitry 22 (e.g., when executing process 30) may obtain an indication or instruction to apply configuration change(s) such as configuration change(s) indicated by command(s) 36 (FIG. 3). As described in connection with FIG. 3, the indication or instruction may be obtained by processing circuitry 22 as input from equipment 12 (e.g., an administrator device, a device management server, etc., via interface(s) 34).

Prior to applying configuration update 38, processing circuitry 22 may store a copy of the current version of running configuration 32 as the (new) most recent previous running configuration 42. Processing circuitry 22 may then apply the configuration update 38 to the running configuration 32, resulting in a new current version (i.e., an updated version) of running configuration 32 after applying update 38. In other words, processing circuitry 22 may replace the previous version of running configuration 32 (e.g., saved as the most recent previous running configuration 42 prior to its replacement) with a new version of running configuration 32 that incorporates change(s) in configuration update 38.

Responsive to configuration update 38 being applied to running configuration 32, processing circuitry 22 may generate a new configuration difference record 52 for configuration update 38. A record 52 (e.g., the new record 52 generated for a given configuration update 38) may include configuration difference information 54 identifying and/or containing each of the configuration differences (e.g., additions, removals, modifications, or other changes) between versions of running configuration 32 before and after the configuration update has been applied.

Because a previous version of running configuration (e.g., running configuration 42) is stored in configuration history 44 prior to update 38 being applied, processing circuitry 22 may compare the version of running configuration 32, after update 38 has been applied, to the previous version of running configuration to obtain each of the differences between the two versions of running configuration. This comparison may be performed in any suitable manner, depending on how the current and past versions of running configuration are maintained on memory circuitry 24. In illustrative configurations in which running configuration 32 and running configuration 42 are each stored separately as a complete collection of respective versions of running configuration data, the two collections of configuration data may be compared to identify the difference(s). In illustrative configurations in which running configuration 32 and running configuration 42 are each stored as a version (or a revision) of an original reference collection of configuration data (e.g., in a Git repository or a repository that provides other types of version control mechanism), the two versions or revisions may be compared instead of comparing two separate collections of running configuration data.

Record 52 may also provide additional information indicating the context of the configuration update. Examples of this contextual information may include user information 56, configuration session information 58, timing information 60. In particular, user information 56 may contain user-identifying information such as a username, user login credentials, a user identity certificate, and/or other user information associated with configuration update 38. For example, configuration update 38 may be based on commands 36 received via a secure session between equipment 12 and network device 10. The means (e.g., the use of the username, the user login credentials, the user certificate, etc. ,) by which the secure session is established, by which user identity is validated, and/or by which network device 10 is generally accessed may be stored as user information 56. User information 56 may identify the user (e.g., network administrator) on whose authority the configuration update 38 is applied.

Configuration session information 58 may identify how commands 36 (FIG. 3) for configuration update 38 are received. In particular, information 58 may include a session name or another session identifier that indicates a configuration session initiated to provide configuration changes that are subsequently applied (e.g., committed). In instances where a command 36 for a configuration change is not obtained in a configuration session (e.g., is received as a single line command in a command line interface), information 58 may be omitted from record 52 or information 58 may indicate a configuration update based on a command (e.g., a single-line command) outside of a configuration session.

Timing information 60 may provide a timestamp or otherwise identify a time at which configuration update 38 is applied, at which running configuration 32 has been updated, and/or at which record 52 is generated. If desired, other types of timing information in connection with configuration update 38 may be provided as timing information 60.

The types of information contained within each record 52 shown in and described in connection with FIG. 4 is merely illustrative. If desired, other information may also be included in record 52 instead of or in addition to information 54, 56, 58, and 60. If desired, memory circuitry 24 may maintain a history 62 of configuration updates (e.g., a history of configuration differences associated with the updates) that includes numerous configuration difference records 52, each responding to a different configuration update 38 but generated in an analogous manner as described above,

By generating configuration difference 54 and corresponding contextual information (e.g., in a new record 52) based on a configuration update 38 being applied, network device 10 may provide external equipment (e.g., equipment 14) with one or notifications containing configuration difference 54 and/or corresponding contextual information in response to each configuration update to network device configuration information. In particular, because the information in record 52 conveyed to equipment 14 is concise, the configuration update and the context of configuration update can be quickly parsed by a network administrator (e.g., operating equipment 14 that receives the notification).

In some illustrative configuration described herein, the same configuration management process 30 is shown and described to maintain (e.g., generate, store, update, etc.) configuration difference record(s) 52. However, if desired, processing circuitry 22 may execute other processes in addition to or instead of process 30 to perform the operations described in connection with FIG. 4. In general, the process(es) executed by processing circuitry 22 may be organized in any suitable manner. Accordingly, the operations described herein with respect to FIGS. 3-6 may be generally referred to as being performed by processing circuitry 22 (e.g., one or more processors of processing circuitry 22) rather than referring specifically to one or more processes performing these operations.

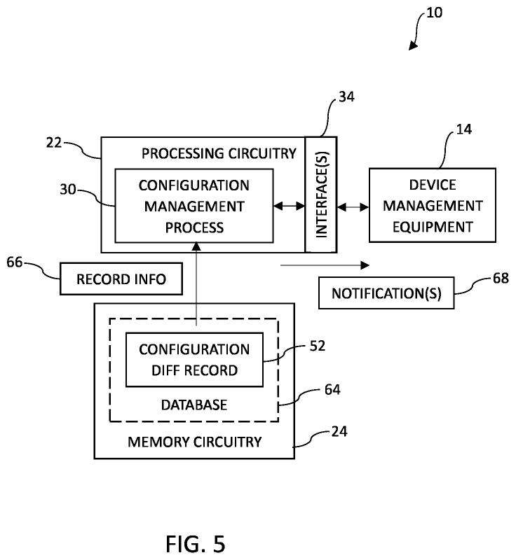

Based on a configuration update being applied to running configuration and after configuration difference 54 has been determined and record 52 has been generated, network device 10 may output a notification indicative of the configuration difference external device management equipment (e.g., an administrator device). FIG. 5 is a diagram of illustrative network device processing circuitry configured to provide configuration difference information to device management equipment 14.

As shown in FIG. 5, processing circuitry 22 (e.g., when executing process 30) may obtain information 66 from a newly generated configuration difference record 52 stored on memory circuitry 24 for a configuration change (e.g., configuration change 38 in FIG. 4). Information 66 may include one or more (e.g., all) of information 54, 56, 58, and 60 in FIG. 4 and/or other information in record 52. In one illustrative configuration sometimes described herein as an example, information 66 may include configuration difference 54 and at least one of (e.g., all of) contextual information 56, 58, and 60. Processing circuitry 22 may provide one or more notifications 68 containing record information 66 to device management equipment 14.

Processing circuitry 22 may transmit notification 68 via a corresponding (software) interface 34 such as an applicable programming interface (and corresponding network interface(s) 28 of device 10 in FIG. 2). In some instances, equipment 14 (e.g., an administrator device or a management server) may be subscribed to receive notifications from network device 10 in response to any changes to a portion of a database (e.g., database 64). As an example, processing circuitry 22 (e.g., when executing process 30) may publish the newly generated record 52 and/or the information therein in database 64. Responsive to the newly published record information, processing circuitry 22 (e.g., when executing process 30 and/or when executing a process that provides subscription and notification services) may obtain the desired information 66 from the published record information and convey information 66 in a notification 68 to subscribing device management equipment 14. If desired, information 66 may be conveyed to equipment 14 in other manners.

The operations described in connection with FIG. 5 may occur with each instance of configuration change 38 (FIG. 4) and with generation of each configuration difference record corresponding to the respective configuration change 38. Accordingly, network device 10 may notify device management equipment 14 of configuration changes 38 in real-time and provide easily digestible information (e.g., information 54, 56, 58, and/or 60) to device management equipment 14. Advantageously, device 10, configured in this manner, may simplify monitoring of device configuration information (e.g., by obviating the need for equipment 14 to periodically check or poll device 10 to determine whether configuration updates have occurred) and may allow equipment 14 (e.g., the network administrator operating equipment 14) to make assessments on whether the configuration update is appropriate (e.g., is intended, is performed by an authorized user, etc.) more easily based on information 54, 56, 58, and/or 60.

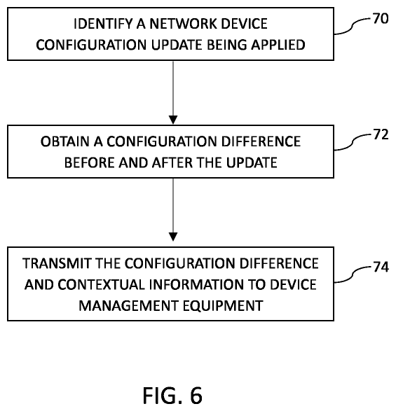

FIG. 6 is a flowchart of illustrative operations for notifying device management equipment of network device configuration differences. In particular, these operations may be performed by one or more processors of network device 10 (e.g., control plane processing circuitry 22 in FIG. 2) using other components of network device 10 (e.g., memory circuitry 24, interfaces 28, etc., in FIG. 2). In some configurations described herein as an illustrative example, the operations described in connection with FIG. 6 may be performed by the one or more processors by executing software instructions stored on memory circuitry (e.g., one or more non-transitory computer-readable storage media). If desired, one or more operations described in connection with FIG. 6 may be performed by and/or using other hardware components in network device 10.

At block 70, one or more processors of a network device (e.g., forming control plane processing circuitry 22) may identify a network device configuration update (e.g., update 38 in FIGS. 3 and 4) being applied. The configuration update may be applied to a current version of running configuration (e.g., a previous version of running configuration 32 saved as running configuration 42 in FIG. 4) and may result in an updated version of the running configuration (e.g., an updated version of running configuration 32 that replaced the previous version of running configuration 32) after the update is applied. The one or more processors may receive an indication to apply the configuration update via an interface (e.g., interface 34) such as a command line interface and/or via an applicable programming interface. The indication may be an instruction to commit changes made in a configuration session or may receive a single-line command in a configuration mode outside of the configuration session, as two illustrative examples. If desired, the changes to the configuration may be specified using one or more commands (e.g., received via the command line interface) in the configuration session or in the single-line command.

At block 72, the one or more processors may obtain (e.g., determine) a difference (e.g., configuration difference 54 in FIG. 4) in the network device configuration before and after the configuration change (e.g., between the current and the updated versions of the running configuration 32 in FIG. 4).

In illustrative configurations described herein as an example, the configuration difference may be obtained from a corresponding configuration different record (e.g., record 52 in FIGS. 4 and 5). The record may be generated by the one or more processors to contain configuration difference and contextual information associated with the configuration change (e.g., information 66 from record 52 in FIGS. 4 and 5).

At block 74, the one or more processors may transmit (e.g., output) the determined configuration difference and contextual information associated with the configuration change to external device management equipment (e.g., equipment 14 in FIG. 5). This configuration difference information and contextual information may be conveyed in a notification (e.g., notification 68 in FIG. 5) to the device management equipment. The contextual information may indicate a context in which the indication (e.g., instruction or command) to apply the configuration update is received. As example, the contextual information may identify a user that provided the indication to apply the update (e.g., may include information 56 in FIG. 4), may identify a time at which the update is applied (e.g., may include information 60 in FIG. 4), and/or may identify a configuration session from which changes for the update are applied (e.g., may include information 58 in FIG. 4).

The methods and operations described above in connection with FIGS. 1-6 may be performed by the components of one or more network devices 10 (FIG. 1) and/or one or more servers or other host equipment using software, firmware, and/or hardware (e.g., dedicated circuitry or hardware). Software code for performing these operations may be stored on one or more non-transitory computer-readable storage media (e.g., tangible computer-readable storage media) stored on one or more of the components of the network device(s) and/or server(s) or other host equipment. The software code may sometimes be referred to as software, data, instructions, program instructions, or code. The one or more non-transitory computer-readable storage media may include drives, non-volatile memory such as non-volatile random-access memory (NVRAM), removable flash drives or other removable media, other types of random-access memory, etc. Software stored on the non-transitory computer readable-storage media may be executed by processing circuitry on one or more of the components of the network device(s) and/or server(s) or other host equipment (e.g., compute devices of server equipment, processing circuitry of computing devices, processing circuitry of network devices, etc.).

The foregoing is merely illustrative and various modifications can be made to the described embodiments. The foregoing embodiments may be implemented individually or in any combination.

What is claimed is:

1. A network device comprising:
memory circuitry; and
processing circuitry coupled to the memory circuitry and configured to:
identify an update to be applied to a current version of device configuration information that results in an updated version of the device configuration information;
obtain a difference between the updated version of the device configuration information and the current version of the device configuration information; and
transmit, to device management equipment, a notification that includes the difference between the updated version of the device configuration information and the current version of the device configuration information.

2. The network device defined in claim 1, wherein the processing circuitry is configured to receive, via an interface, an indication to apply the update to the current version of the device configuration information.

3. The network device defined in claim 2, wherein the notification further includes information indicative of a context in which the indication to apply the update is received.

4. The network device defined in claim 3, wherein the information identifies a user that provided the indication to apply the update.

5. The network device defined in claim 3, wherein the information identifies a time at which the update is applied.

6. The network device defined in claim 3, wherein the information identifies a configuration session or a user-input configuration command based on which changes for the update are applied.

7. The network device defined in claim 2, wherein the interface comprises a command line interface or an application programming interface.

8. The network device defined in claim 2, wherein the indication to apply the update is received from configuration updating equipment separate from the device management equipment.

9. The network device defined in claim 1, wherein the memory circuitry is configured to store the current version of the device configuration information separately from the updated version of the device configuration information.

10. The network device defined in claim 9, wherein the processing circuitry is configured to obtain the difference between the updated version of the device configuration information and the current version of the device configuration information by comparing the stored current version of the device configuration information with the stored updated version of the device configuration information.

11. The network device defined in claim 1, wherein the memory circuitry is configured to store the current version of the device configuration information and the updated version of the device configuration information as first and second versions of device configuration information, respectively, in a repository that provides a version control mechanism.

12. The network device defined in claim 11, wherein the processing circuitry is configured to obtain the difference between the updated version of the device configuration information and the current version of the device configuration information by comparing the first version with the second version.

13. A network device comprising:
memory circuitry; and
processing circuitry coupled to the memory circuitry and configured to:
generate a configuration difference record that identifies a difference between first and second versions of running configuration based on a configuration update and contextual information for the configuration update; and
transmit, to device management equipment, the difference between the first and second versions of running configuration and the contextual information for the configuration update.

14. The network device defined in claim 13, wherein the processing circuitry is configured to:
receive one or more commands for the configuration update;
apply the configuration update to replace the first version of running configuration with the second version of running configuration; and
store the first version of running configuration in the memory circuitry prior to applying the configuration update.

15. The network device defined in claim 14, wherein the processing circuitry is configured to obtain the difference between the first and second versions of running configuration by determining a difference between the second version of running configuration after applying the configuration update is applied and the first version of running configuration stored prior to applying the configuration update.

16. The network device defined in claim 13, wherein the contextual information comprises information indicative of a user that made the configuration update, information indicative of a time associated with the configuration update, or information indicative of a configuration session associated with the configuration update.

17. A method of operating a network device, the method comprising:
receiving, by the network device, an instruction to apply a configuration update to a running configuration of the network device; and
outputting, by the network device and to device management equipment, information identifying one or more changes to the running configuration after applying the configuration update, user information identifying a user that provided the configuration update, and timing information indicative of a time at which the configuration update is applied.

18. The method defined in claim 17 further comprising:
storing a version of the running configuration prior to applying the configuration update;
determining the one or more changes to the running configuration based on the stored version of the running configuration and an additional version of the running configuration after applying the configuration update; and
storing the one or more changes in a record among a plurality of records that provide a configuration update history.

19. The method defined in claim 17, wherein the instruction to apply the configuration update to the running configuration comprises input received via a command line interface.

20. The method defined in claim 17, wherein the configuration update is specified in a configuration session, the method further comprising:
outputting, by the network device and to the device management equipment, information identifying the configuration session.
